(19) United States
(12) Patent Application Publication
(10) Pub. No.: US 2021/0041943 A1
(43) Pub. Date: Feb. 11, 2021

(54) EYE TRACKING ARCHITECTURE

(71) Applicants: Interface Technology (ChengDu) Co., Ltd., Chengdu (CN); Interface Optoelectronics (ShenZhen) Co., Ltd., Shenzhen (CN); General Interface Solution Limited, Miaoli County (TW)

(72) Inventor: PO-CHING LIN, Miaoli County (TW)

(21) Appl. No.: 16/550,439

(22) Filed: Aug. 26, 2019

(30) Foreign Application Priority Data
Aug. 9, 2019 (CN) 201910737436.1

(51) Int. Cl. G06F 3/01; H04N 5/33

(52) U.S. Cl. CPC G06F 3/013; H04N 5/332

(57) ABSTRACT

An eyeball tracking architecture comprises a hot mirror, an infrared light source, and a camera. The hot mirror is disposed between a display in a head mounted display device and a human eye. The camera is disposed in the head mounted display and connected to a control circuit. The camera captures images of the infrared pattern reflected by the hot mirror, captures images of the human eye, and captures composite images of the infrared pattern and the eye and sends the image data to the control circuit. The control circuit performs compensation calculations using a line of sight mapping function, and calculates a position where the line of sight falls on the display. Then, the control circuit controls the display to display data relevant to and according to the image data and eye position.

### CROSS-REFERENCE TO RELATED APPLICATIONS

This non-provisional application claims priority under 35 U.S.C. § 119(a) on Patent Application No(s). 201910737436.1 filed in China on Aug. 9, 2019, the entire contents of which are hereby incorporated by reference.

### BACKGROUND OF THE INVENTION

### Field of the Invention

The present invention relates to eye tracking devices, and more particularly to an eye tracking architecture that utilizes a hot mirror to reflect infrared light and then determines eye position and tracking by comparing the user's pupil with the infrared pattern on the hot mirror.

### Description of the Prior Art

Eyeball tracking technology originated in medical research and development. With advancements in technology it has been applied in commercial applications and has been used in a variety of devices such as mobile phones, computers, and automobiles.

Eye tracking was derived from gaze point rendering technology. With improvements in the development of the augmented reality (AR) and virtual reality (VR) industry, eye tracking has been used to reduce CPU load by 30%-70%. In addition to reducing hardware requirements and costs, the user experience is improved.

Currently, eye tracking technology is mainly divided into intrusive and non-invasive methods and realized using hardware. In the non-invasive architecture, the following main methods are used.

User movement is speculated according to changes in head and facial positions.

The eyeball and the characteristic changes around the eyeball are followed by shape tracking.

Changes in the iris affect the shape tracking.

The infrared beam is actively projected onto the iris.

Refer to FIG. 1A and FIG. 1B. The active infrared beam is projected onto the iris. A light source 11 shines on the eyes 12 to the pupil 13 and the cornea 14. Using the pupil 13 as a reference, the pupil 13 and the cornea 14 are imaged by a camera 15. Movement of the eye 12 is tracked and is recorded to obtain eye movement data. A graphic processing and tracking algorithm is then performed to calculate the line of sight vector in relation to time.

Refer to FIG. 2. Additional features are extracted by the projected active infrared beam to achieve better registration precision. However, the infrared beam 21 is easily absorbed by the iris and crystalline lens 22 of the eye. As a result, the retina 23 is easily burned and cataracts are more likely to form over time. Therefore, how to control the energy of the light source projected onto the eyeball and how to safely monitor and stop operation when the device is operating abnormally has been a major focus of technology development.

It can be seen that there are disadvantages in the prior art that need to be improved.

### SUMMARY OF THE INVENTION

In view of the above, the inventor of the present invention has been engaged in the design, manufacturing, and development of related products for many years. After detailed design and careful evaluation of the objectives, the present invention has finally become practical.

An object of the present invention is to provide an eye tracking architecture that utilizes a hot mirror design which allows visible light transmission but reflects infrared light and blocks ultraviolet light. Eyeball position and tracking calculations are performed using a camera to compare the pupil and the infrared pattern (IR pattern) on the hot mirror. The tracking accuracy is improved by not actively projecting the infrared beam onto the user's eye, and at the same time eyeball damage is avoided.

The present invention provides an eye tracking architecture design, which comprises a hot mirror (also known as a heat mirror, IR cut filter, heat reflection filter), an infrared light source, and a camera. The hot mirror is disposed on a head mounted display between the display monitor and the user's eye.

The infrared light source is disposed in the head mounted device display. A control circuit controls the infrared light source and an analyzer for measuring the movement locus eye of the infrared pattern on the hot mirror. The hot mirror reflects the infrared light and a pattern is formed on the hot mirror of the reflected infrared light (IR light pattern).

The control circuit also controls the camera of the head mounted display device. The camera captures images of the infrared pattern reflected by the hot mirror, captures images of the user's eye, and captures composite images of the infrared pattern image and the eye image. Image data is transferred to the control circuit so that the line of sight is calculated by a mapping function compensation calculation. The line of sight data provides feedback to the display so that eyeball movement and position generates display control data to affect the display.

The hot mirror reflects infrared light so that infrared light is not actively projected onto the user's eye thereby preventing eye damage while improving the accuracy of the eye tracking system.

### BRIEF DESCRIPTION OF THE DRAWINGS

To further understand and understand the purpose, shape, structure and function of the present invention, the present invention will be described in detail and illustrated in the drawings as follows:

FIG. 1A is a drawing illustrating a movable infrared light beam projected onto an eye;

FIG. 1B is a drawing illustrating a movable infrared light beam projected onto an eye;

FIG. 2 is a drawing illustrating absorption of light sources by an eye;

FIG. 3 is a drawing illustrating an eye tracking architecture according to an embodiment of the present invention;

FIG. 4 is a drawing illustrating an image capture and mapping function of an eye tracking architecture according to an embodiment of the present invention;

FIG. 5 is a flowchart of an image capture and mapping function of an eye tracking architecture according to an embodiment of the present invention; and

FIG. 6 is a drawing illustrating an eye tracking architecture according to an embodiment of the present invention.

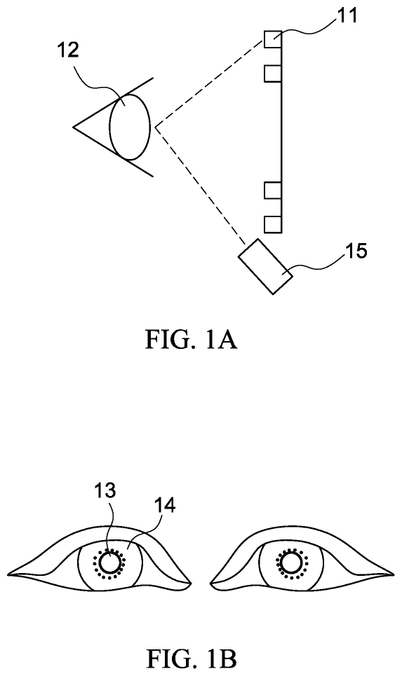

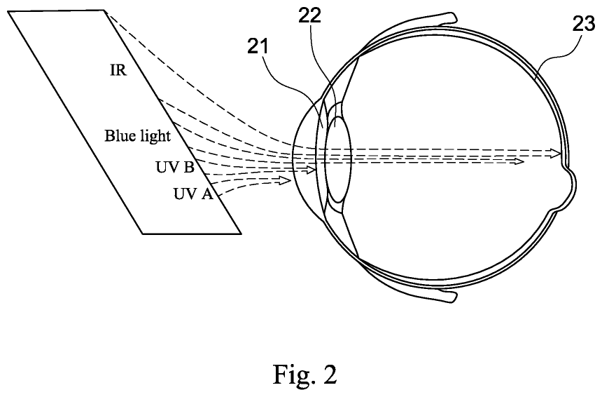

### DESCRIPTION OF THE PREFERRED EMBODIMENTS

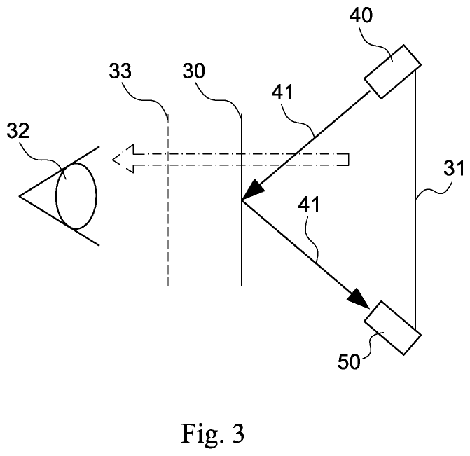

Refer to FIGS. 3, 4, and 5. The eye tracking architecture of the present invention comprises a hot mirror 30, an infrared light source 40, and a camera 50.

The hot mirror 30 is disposed in a head mounted display device between a display 31 and a user's eye 32.

The infrared light source 40 is provided to the headset display 31. A control circuit (not shown) controls the infrared light source 40 and an analyzer for measuring the movement locus of the infrared pattern on the hot mirror 30. The hot mirror 30 reflects infrared light 41 and an infrared pattern 42 is formed on the hot mirror 30.

The camera 50 is provided in the head mounted device display 31 and electrically connected to the control circuit. The camera captures images of the infrared pattern 42 on the heat mirror 30, captures images of the human eye 32, and captures composite images 52 of the eye 32 and infrared pattern 42 and transmits the image data to the control circuit.

The control circuit performs compensation calculations by a line of sight mapping function. The line of sight is deduced and provided to the display 31. According to the feedback of the eye position and movement data, the display is controlled so that eye movement and position affects the display 31, the display data, and what/how data is displayed on the display 31.

The hot mirror 30 reflects infrared light so that infrared light is not actively projected onto the user's eye thereby preventing eye damage while improving the accuracy of the eye tracking system.

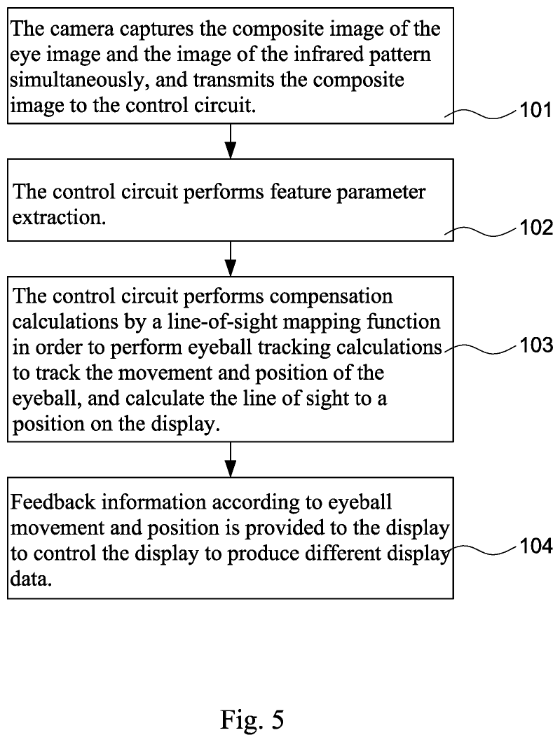

Refer to FIG. 5. The imaging functions of the eye tracking architecture of the present invention comprises the following steps:

Step 101: The camera 50 captures the composite image 52 of the eye image 51 and the image of the infrared pattern 42 simultaneously, and transmits the composite image 52 to the control circuit.

Step 102: The control circuit performs feature parameter extraction.

Step 103: The control circuit performs compensation calculations by a line-of-sight mapping function in order to perform eyeball tracking calculations to track the movement and position of the eyeball, and calculate the line of sight to a position on the display 31.

Step 104: Feedback information according to eyeball movement and position is provided to the display 31 to control the display to produce different display data.

For example, movement of the eye is calculated by the mapping function in the line of sight of the display 31 and as the line of sight changes, feedback control is sent to the display.

Referring to FIGS. 3, 4, and 5, the infrared pattern 42 comprises a grid pattern, a dot, a dot pattern, a net, or a composite pattern.

In an embodiment of the present invention the display 31 comprises a transparent display, an opaque display, or a projection display.

In an embodiment of the present invention the display 31 comprises an OLED display device, a liquid crystal display (LCD), or a micro light-emitting diode display (Micro LED display).

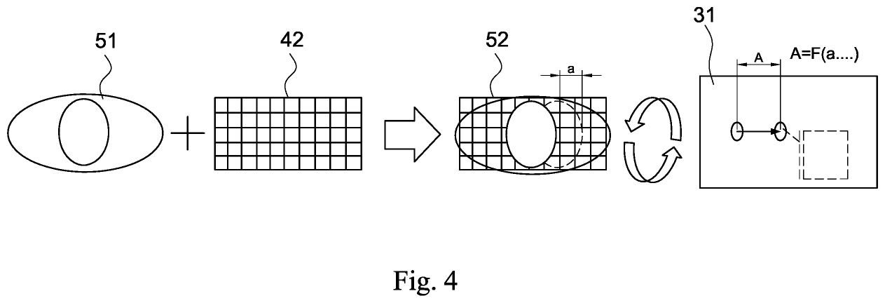

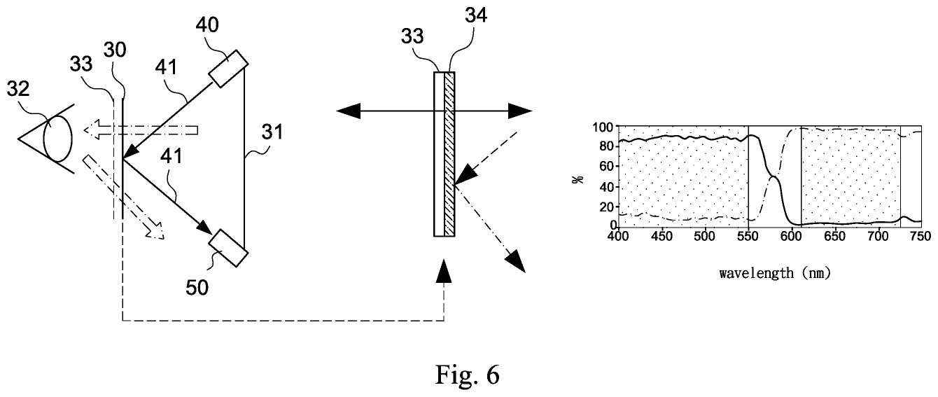

Refer to FIGS. 4, 5, and 6. The hot mirror 30 is disposed between the user's eye 32 and a combination lens assembly 33 of the display 31 providing an enhanced display effect such as optical path correction, image magnification, or image distortion compensation.

The hot mirror 30 is bonded to the lens assembly 33. For example, the hot mirror 30 comprises an integrated composition coating 33.

In an embodiment of the present invention the head mounted display device comprises a headset type augmented reality (AR) environment display device or a headset type virtual reality (VR) display device.

The above description comprises the best embodiments of the present invention, but the structural features of the present invention are not limited thereto, and any change or modification that can be easily considered by those skilled in the art can be covered.

1. An eye tracking architecture comprising:
a hot mirror, the hot mirror disposed in a head mounted display device between an infrared light source and a user's eye for reflecting infrared light, wherein the hot mirror is parallel to a display;
the infrared light source disposed in the head mounted display device;
a control circuit for controlling the infrared light source;
an analyzer electrically connected to the control circuit for measuring eye movement, eye position, and an infrared light pattern on the hot mirror;
a camera disposed in the head mounted display device and electrically connected to the control circuit for capturing images of the infrared light pattern on the hot mirror, capturing images of eye movement and position, and capturing composite images of the infrared light pattern and the eye; and
a lens assembly disposed between the hot mirror and the user's eye, wherein the lens assembly is parallel to the hot mirror;
wherein image data is transmitted to the control circuit for performing compensation calculation by a line of sight mapping function, calculating position of the line of sight on the display, and controlling the display to provide different display information based on eye position.

2. The eye tracking architecture of claim 1, wherein the infrared pattern comprises a grid pattern, a dot, a dot pattern, a net, or a composite pattern.

3. The eye tracking architecture of claim 1, wherein the display comprises a transparent display, an opaque display, or a projection display.

4. The eye tracking architecture of claim 1, wherein the display comprises an OLED display device, a liquid crystal display (LCD), or a micro light-emitting diode display (Micro LED display).

5. (canceled)

6. The eye tracking architecture of claim 1, wherein the hot mirror lens assembly provides optical path correction, image magnification or image distortion compensation.

7. The eye tracking architecture of claim 1, wherein the head mounted display device comprises a headset type augmented reality (AR) environment display device or a headset type virtual reality (VR) display device.
